(19) United States
(12) Patent Application Publication
(10) Pub. No.: US 2004/0205607 A1
(43) Pub. Date: Oct. 14, 2004

(54) Printing method using Nup function, and computer readable recording medium storing computer program for executing the printing method

(75) Inventors: So-hye Kim, Suwon-Si (KR); Ki-kwon Bae, Seoul (KR); Seung-Jin Cho, Suwon-si (KR); Seung-wan Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/750,215

(22) Filed: Jan. 2, 2004

(30) Foreign Application Priority Data
Jan. 3, 2003 (KR) 2003-371
Jan. 18, 2003 (KR) 2003-3469
Mar. 10, 2003 (KR) 2003-14753
Apr. 7, 2003 (KR) 2003-21623

(51) Int. Cl. G06F 17/21

(52) U.S. Cl. 715/517

(57) ABSTRACT

A printing method using a multiple pages per side (Nup) function, and a computer readable recording medium storing a computer program to execute the printing method, includes processing and printing only data of a page set to be multiple printed as data to be multiple printed; or processing and printing data of a page to be printed according to N set for a group to which the page required to be printed belongs; or generating a number indicating the quantity of the multiple pages to be printed on a physical page according to a set printing environment and multiple-printing the plurality of pages together with corresponding page numbers according to the printing environment according to the processed data and the generated number of multiple pages; or reducing identical contents and copying the reduced contents by a predetermined number of times, and printing the copied result on a sheet of paper, in response to a user selecting a repetition printing function; or performing a multiple-printing operation using a value of N that has been arbitrarily set by the user.

### CROSS-REFERENCE TO RELATED APPLICATIONS

This application claims the priority of Korean Patent Application Nos. 2003-371, filed on Jan. 3, 2003, 2003-3469, filed on Jan. 18, 2003, 2003-14753, filed on Mar. 10, 2003, and 2003-21623, filed on Apr. 7, 2003, in the Korean Intellectual Property Office, the disclosures of which are incorporated herein in their entirety by reference.

### BACKGROUND OF THE INVENTION

1. Field of the Invention

The present invention relates to a printing method, and, more particularly, to a method of printing a document comprising a plurality of pages using a multiple pages per side (Nup) function of printing several pages on one sheet of paper, and a computer readable recording medium storing a computer program to execute the printing method.

2. Description of the Related Art

Typically, a computer and a printer are indispensable office automation devices. To print a computer document using a printer, the computer requires a printer driver. The printer driver converts page data written by an application program of the computer into data that can be interpreted by the printer. In other words, when a printing command regarding printing data written by the application program of the computer is received, the printer driver divides the printing data into units of pages, properly processes data and control codes contained in the printing data according to each page, converts the result of the processing into data that can be interpreted by the printer, and then transmits the data to the printer via a communication interface. The printer driver has a function of processing printing materials printed on user's demands. As such, by setting a sheet of paper on which data is to be printed, and changing various options in a printing environment, the readability of the document is improved.

In general, the printer prints one page of the document on a sheet of paper. However, by using a multiple pages per side (Nup) function, several pages are reduced, and then the reduced pages are printed on one sheet of paper, thereby saving paper and ink or toner. The multiple pages per side (Nup) function can be performed by the printer driver. The multiple pages per side (Nup) function is a method of printing N (where N is a positive integral number more than 1) pages on one sheet of paper. For example, when Nup=2up (N=2), two pages are printed on one sheet of paper, and when Nup=4up (N=4), four pages are printed on one sheet of paper.

In order to implement a multiple pages per side (Nup) function, when a plurality of pages per sheet of paper are printed using the printer driver or the application program, a plurality of pages of a document per sheet of paper are processed and printed collectively. The multiple pages per side (Nup) function is useful when a document having a plurality of pages should be roughly checked, and when a user intends to reduce printing quantity. However, when the pages of the document are printed using the multiple pages per side (Nup) function, it is difficult to read or see the pages, particularly complicated contents and forms in a printed document.

Hereinafter, a conventional printing method that causes the above-described problems will be described with reference to the attached drawings.

FIG. 1 illustrates a conventional printing method using a multiple pages per side (Nup) function. Referring to FIG. 1, a printer driver 12 receives N and a command to perform a multiple pages per side (Nup) function from a printer driver user interface 10. In this case, the printer driver 12 calls a multiple pages per side (Nup) module 14 to process collectively all the pages of one document provided from a graphics device interface (GDI) 16. In other words, the printer driver 12 processes all the pages for multiple printing. Here, the GDI 16 converts the document written by the application program into computer languages that can be interpreted by the printer driver 12.

In general, a document to be printed contains pages having different complexities of contents and forms. Nevertheless, in the conventional printing method using the multiple pages per side (Nup) function, N pages are collectively printed on a sheet of paper regardless of complexities of the contents and forms of the pages. Thus, in a given document, pages including simple contents and forms and pages including complicated contents and forms are reduced to the same size and printed. Thus, it is difficult to read or see the pages containing complicated contents and forms after they are printed.

Meanwhile, in the conventional printing method using the multiple pages per side (Nup) function, the page number of a sheet of paper to be multiple printed is not separately printed. Of course, when the sheet of paper is multiple printed by some application programs, such as a word processor, an option of printing the page number of each of the pages contained in the sheet of paper to be printed can be set. However, when the sheet of paper is multiple printed by other application programs, such as Internet Explorer, the page number of each of the pages contained in the sheet of paper to be multiple printed cannot be separately printed.

FIG. 2 illustrates a sheet of paper printed by the conventional printing method using the multiple pages per side (Nup) function. As shown in FIG. 2, when four pages a, b, c, and d are reduced and printed on one sheet of paper, the order in which the four pages a, b, c, and d are to be printed is important. In general, there are four types of layouts in which multiple pages are printed on one paper sheet:

Left to Right, then Down

Top to Bottom, then Right

Right to Left, then Down

Top to Bottom, then Left

The order of the printed pages is a→b→c→d in layout 1. The order of the printed pages is a→c→b→d in layout 2. The order of the printed pages is b→a→d→c in layout 3. The order of the printed pages is b→d→a=43 c in layout 4.

If the page number is not separately printed on the pages contained in the sheet of paper to be printed, only a user who remembers the layout, or who checks the layout in printer driver registration information, can know the proper order of the pages. Other persons cannot easily know the proper order of the pages.

Hereinafter, a conventional printing method using a multiple pages per side (Nup) function of repeatedly printing an identical document on a sheet of paper will be described.

The user writes a document using general application programs. In this case, the user checks the size of the printing paper that the document will be printed on. Next, in consideration of the size of the printing paper, the user reduces the document to be repeatedly printed. In this case, the user copies the reduced document on a sheet of paper by the number of times set by the user and prints the document by a predetermined number of times on the sheet of paper. Consequently, the conventional printing method using the multiple pages per side (Nup) function has a problem in that the user who wants to repeatedly print the same document on one sheet of paper has insufficient experience to reduce the document and copy the reduced document. Further, when the user wants to repeatedly copy the document on the same sheet of paper and modify the document to be printed, the conventional printing method using the multiple pages per side (Nup) function has a problem in that the user has insufficient experience to manually modify several copied documents one by one or to manually manipulate operations of modifying one document and then reducing and copying the modified document.

In the conventional printing method using the multiple pages per side (Nup) function, N is selected from a set of predetermined values. In other words, the number N of pages to be contained in a sheet of paper to be printed is selected from predetermined values. Thus, when the user wishes to simply check the contents of X pages, if the number X of pages to be printed on a sheet of paper does not exist in the set of predetermined values, there are problems that X pages are dispersed and output in several pages or the contents of pages is reduced and output. For example, when the number X of pages that are to be checked by the user is ‘3’, and ‘3’ is not contained in the set of predetermined values, in the conventional printing method the user must print two sheets of paper by setting N to ‘2’ or print one sheet of paper by setting N to ‘4’. As such, the conventional printing method has a problem in that the user cannot print the desired number of pages using the multiple pages per side (Nup) function.

### SUMMARY OF THE INVENTION

The present invention provides a method of printing a document using a multiple pages per side (Nup) function, by which the readability of a printed document and a user's convenience are increased.

The present invention also provides a computer readable recording medium storing a computer program to control a printing apparatus using a variety of multiple pages per side (Nup) functions.

Additional aspects and/or advantages of the invention will be set forth in part in the description which follows and, in part, will be obvious from the description, or may be learned by practice of the invention.

According to an aspect of the present invention, there is provided a printing method using a multiple pages per side (Nup) function, by which a document comprising a plurality of pages is printed using the Nup function of printing multiple pages on a sheet of paper, the method comprising setting pages to be multiple printed out of the plurality of pages, determining whether a page to be printed is one of the pages set to be multiple printed, processing data of the page to be printed as data to be multiple printed in response to determining that the page to be printed is one of the pages set to be multiple printed, processing data of the page to be printed as data to be commercially printed in response to determining that the page to be printed is not one of the pages set to be multiple printed, and printing the plurality of pages according to the processed data.

According to another aspect of the present invention, there is provided a printing method using a multiple pages per side (Nup) function, by which a document comprising a plurality of pages is printed using the Nup function of printing multiple pages on a sheet of paper, the method comprising calculating a data amount of a page to be printed, determining whether the calculated data amount exceeds a predetermined reference data amount, processing data of the page to be printed as data to be multiple printed in response to determining that the calculated data amount does not exceed the predetermined reference data amount, processing data of the page to be printed as data to be commercially printed, and printing the plurality of pages according to the processed data.

According to another aspect of the present invention, there is provided a printing method using a multiple pages per side (Nup) function, by which a document comprising a plurality of pages is printed using the Nup function of printing N pages on a sheet of paper, the method comprising grouping the plurality of pages into at least one group, setting N with respect to each of the at least one group, and determining which of the at least one group a page to be printed belongs to, and processing data of the page to be printed according to the set N for the determined group.

According to another aspect of the present invention, there is provided a printing method using a multiple pages per side (Nup) function, by which a document comprising a plurality of pages is printed using the Nup function of printing multiple pages on a sheet of paper, the method comprising setting a printing environment, processing data of the plurality of pages as data to be multiple printed, according to the set printing environment, generating a number indicating an order of the multiple pages to be printed on the sheet of paper, and multiple-printing the plurality of pages together with corresponding page numbers according to the printing environment according to the processed data and the generated number of multiple pages.

According to another aspect of the present invention, there is provided a printing method using a multiple pages per side (Nup) function, the method comprising determining whether a user has selected a repetition printing function of repeatedly printing identical contents on a sheet of paper, reducing a size of the identical contents in response to determining the user has selected the repetition printing function, copying the reduced contents a predetermined number of times, and printing the copied reduced contents on the sheet of paper.

According to another aspect of the present invention, there is provided a printing method using a multiple pages per side (Nup) function, the method comprising determining whether a multiple pages per side (Nup) function of printing N, where N is a positive integral number more than 1, pages per sheet has been selected, determining whether a user has selected N from predetermined values or has set N arbitrarily in response to determining that the multiple pages per side (Nup) function has been selected, processing printing data corresponding to contents of a page to be included in the sheet using the arbitrarily-set N in response to determining the user has set N arbitrarily, processing printing data using the selected N in response to determining the user has selected N from the predetermined values, and performing a printing operation in accordance with the printing data after processing the printing data, or in response to determining the multiple pages per side (Nup) function has not been selected.

According to another aspect of the present invention, there is provided a computer readable recording medium storing a computer program to control an apparatus to print a document comprising a plurality of pages using a multiple pages per side (Nup) function of printing multiple pages on a sheet of paper, wherein the computer program controls the apparatus to perform a process comprising setting pages to be multiple printed out of the plurality of pages, determining whether a page to be printed is one of the pages set to be multiple printed, processing data of the page to be printed as data to be multiple printed in response to determining that the page to be printed is one of the pages set to be multiple printed, processing data of the page to be printed as data to be commercially printed in response to determining that the page to be printed is not one of the pages set to be multiple printed, and printing the plurality of pages according to the processed data.

According to another aspect of the present invention, there is provided a computer readable recording medium storing a computer program to control an apparatus to print a document comprising a plurality of pages using a multiple pages per side (Nup) function of printing N pages on a sheet of paper, wherein the computer program controls the apparatus to perform a process comprising grouping the plurality of pages into at least one group, setting N with respect to each of the at least one group, and determining which of the at least one group a page to be printed belongs to, and processing data of the page to be printed according to the set N for the determined group.

According to another aspect of the present invention, there is provided a computer readable recording medium storing a computer program to control an apparatus to print a document comprising a plurality of pages using a multiple pages per side (Nup) function of printing multiple pages on a sheet of paper, wherein the computer program controls the apparatus to perform a process comprising recognizing a set printing environment, processing data of the plurality of pages as data to be multiple printed, according to the set printing environment, generating a number indicating an order of the multiple pages to be printed on the sheet of paper, and instructing a printer to multiple-print the plurality of pages together with corresponding page numbers according to the printing environment according to the processed data and the generated number of multiple pages.

According to another aspect of the present invention, there is provided a computer readable recording medium storing a computer program to control an apparatus to print a plurality of images on a sheet of paper, wherein the computer program controls the apparatus to perform a process comprising determining whether a user has selected a repetition printing function of repeatedly printing identical contents on the sheet of paper, reducing a size of the identical contents in response to determining the user has selected the repetition printing function, and copying the reduced contents a predetermined number of times, wherein the copied reduced contents are printed on the sheet of paper.

According to another aspect of the present invention, there is provided a computer readable recording medium storing a computer program to control an apparatus to print a document comprising a plurality of pages using a multiple pages per side (Nup) function of printing multiple pages on a sheet of paper, wherein the computer program controls the apparatus to perform a process comprising determining whether the multiple pages per side (Nup) function of printing N, where N is a positive integral number more than 1, pages per sheet has been selected, determining whether a user has selected N from predetermined values or has set N arbitrarily in response to determining that the multiple pages per side (Nup) function has been selected, processing printing data corresponding to the contents of a page to be included in the sheet using the arbitrarily-set N in response to determining the user has set N arbitrarily, processing printing data using the selected N in response to determining the user has selected N from the predetermined values, and instructing a printer to perform a printing operation in accordance with the printing data after processing the printing data, or in response to determining the multiple pages per side (Nup) function has not been selected.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional printing method using a multiple pages per side (Nup) function;

FIG. 2 illustrates a sheet of paper printed by the conventional printing method using the multiple pages per side (Nup) function;

FIG. 3 is a flowchart illustrating a printing method using the multiple pages per side (Nup) function according to an embodiment of the present invention;

FIG. 4 is a flowchart illustrating the printing method using the multiple pages per side (Nup) function according to another embodiment of the present invention;

FIG. 5 is a flowchart illustrating the printing method using the multiple pages per side (Nup) function according to still another embodiment of the present invention;

FIG. 6 is a block diagram of a printing apparatus using the multiple pages per side (Nup) function according to the embodiment of the present invention illustrated in FIG. 3;

FIGS. 7A through 7C are exemplary drawings for explaining the printing methods according to the embodiments of the present invention illustrated in FIGS. 3 and 4;

FIGS. 8A and 8B are exemplary drawings explaining the printing method according to the embodiment of the present invention illustrated in FIG. 5;

FIG. 9 is a flowchart illustrating the printing method using the multiple pages per side (Nup) function according to yet another embodiment of the present invention;

FIG. 10 is a block diagram of the printing apparatus using the multiple pages per side (Nup) function according to the embodiment of the present invention illustrated in FIG. 4;

FIGS. 11A through 11C are exemplary drawings of sheets of papers printed by the printing method according to the embodiment of the present invention illustrated in FIG. 9;

FIG. 12 is a flowchart illustrating the printing method using the multiple pages per side (Nup) function according to yet another embodiment of the present invention;

FIG. 13 is a block diagram of the printing apparatus using the multiple pages per side (Nup) function according to the embodiment of the present invention illustrated in FIG. 5;

FIG. 14 is a flowchart illustrating the printing method using the multiple pages per side (Nup) function according to yet another embodiment of the present invention;

FIG. 15 illustrates an example of a user interface'screen provided in a conventional printing method;

FIG. 16 illustrates an example of a user interface screen provided in a printing method using the multiple pages per side (Nup) function according to an embodiment of the present invention;

FIG. 17 illustrates an example of a user interface screen displayed when a custom menu of the user interface screen shown in FIG. 16 is selected; and

FIG. 18 is a block diagram of the printing apparatus using the multiple pages per side (Nup) function according to the embodiment of the present invention illustrated in FIG. 9.

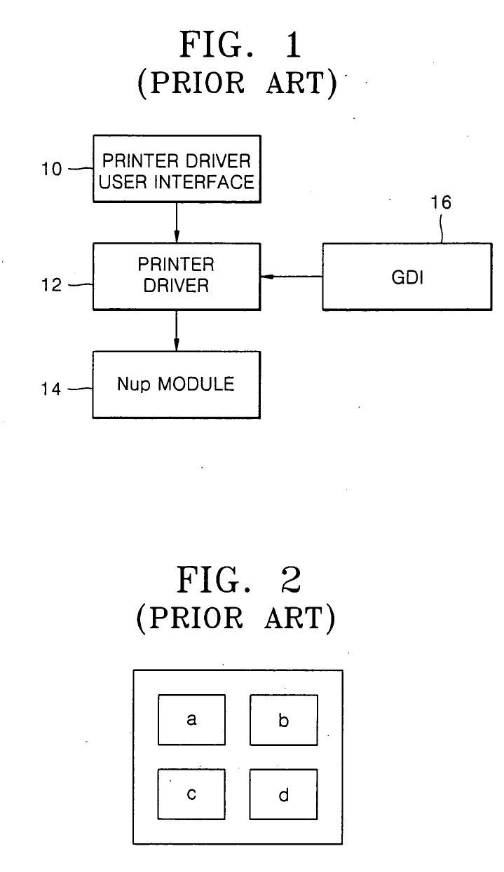

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a printing method of multiple printing only a page selected according to the characteristics of pages of a document to be printed using a multiple pages per side (Nup) function according to embodiments of the present invention will be described in detail with reference to the accompanying drawings. Here, a multiple pages per side (Nup) function is a function of printing several pages on a sheet of paper, for example, a single sheet.

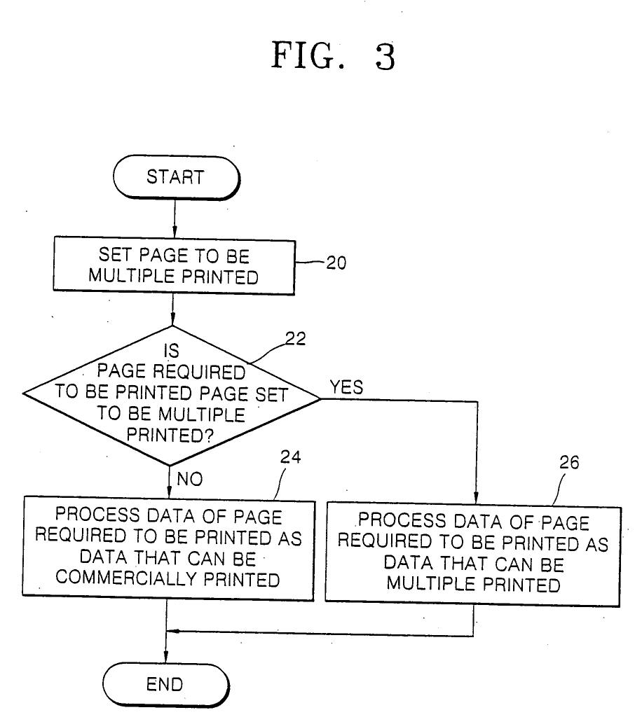

FIG. 3 is a flowchart illustrating a printing method using the multiple pages per side (Nup) function according to an embodiment of the present invention.

In operation 20, in order to print a document comprising a plurality of pages, pages to be multiple printed, or pages not to be multiple printed, out of the plurality of pages of the document are set by a user. In this case, the user can set the number N of pages to be multiple printed on a sheet of paper.

After operation 20, in operation 22, it is determined whether a page currently required to be printed is a page that is set to be multiple printed. Here, when the user requires printing of a document, operation 22 can be performed.

If it is determined that the page required to be printed is not the page set to be multiple printed, in operation 24, data of the page required to be printed is processed as data that can be commercially printed. Here, commercial printing, as a relative concept of multiple printing, is printing of only a single page on a sheet of paper. However, if it is determined that the page required to be printed is the page set to be multiple printed, in operation 26, data of the page required to be printed is processed as data that can be multiple printed. In this case, the page required to be printed is printed according to the data processed in operation 24 or 26.

In operation 20, the user can set a page including simple contents and forms as a page to be multiple printed, and can set a page including complicated contents and forms as a page required to be commercially printed. Thus, when the document has pages including simple contents and forms and pages including complicated contents and forms, in the printing method according to this embodiment of the present invention, the pages including complicated contents and forms are commercially printed on a sheet of paper, instead of multiple printing the pages including complicated contents and forms. Likewise, N pages, including simple contents and forms, are multiple printed on the sheet of paper, instead of commercially printing the page including simple contents and forms.

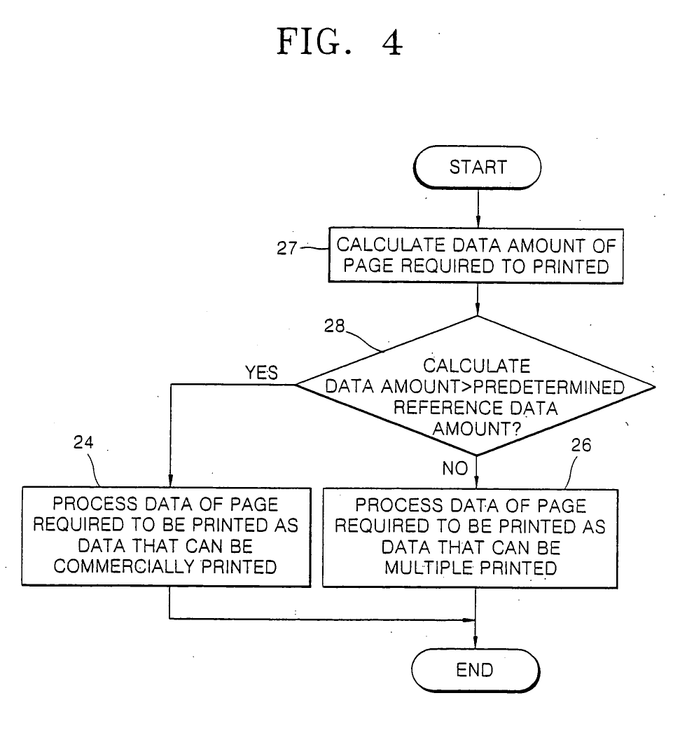

FIG. 4 is a flowchart illustrating the printing method using the multiple pages per side (Nup) function according to another embodiment of the present invention.

In operation 27, in order to print a document comprising a plurality of pages, first, a data amount of a page required to be printed is calculated. In operation 28, it is determined whether the calculated data amount exceeds a predetermined reference data amount. Here, an average data amount of pages including complicated contents and forms may be previously determined, and the user can also set the predetermined reference data amount experimentally.

If it is determined that the calculated data amount exceeds the reference data amount, in operation 24, the page required to be printed is regarded as a page including complicated contents and forms, and data of the page required to be printed is processed as data that can be commercially printed. However, if it is determined that the calculated data amount does not exceed the reference data amount, in operation 26, the page required to be printed is regarded as a page including no complicated contents and forms, and data of the page required to printed is processed as data that can be multiple printed. In this case, the page required to be printed is printed according to the data processed in operations 24 or 26.

Here, the predetermined reference data amount is set before the printing of the document is required by the user. When the printing of the document is required by the user, the printing method shown in FIG. 4 can be performed.

Hereinafter, a printing method using the multiple pages per side (Nup) function by which pages are grouped according to the characteristic of pages of a document to be printed, and which can be printed as different numbers of N pages with respect to each group, according to still another embodiment of the present invention will be described with reference to the accompanying drawings.

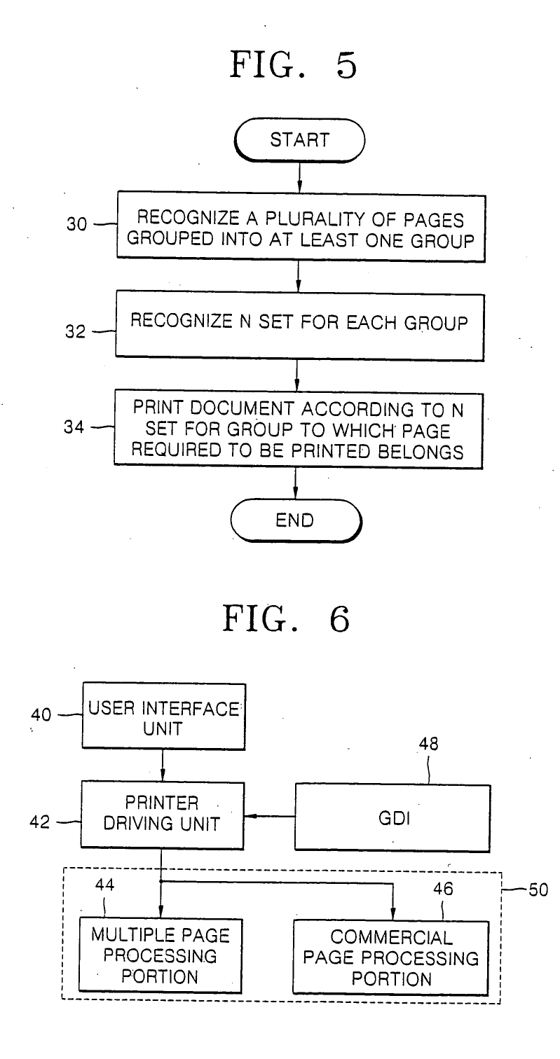

FIG. 5 is a flowchart illustrating the printing method using the multiple pages per side (Nup) function according to this embodiment of the present invention.

In operation 30, in order to print a document comprising a plurality of pages, the plurality of pages grouped into at least one group are recognized. In operation 32, the quantity N set with respect to each of the at least one group is recognized.

According to this embodiment of the present invention, the plurality of pages can be directly grouped by the user or can be automatically grouped based on a predetermined reference data amount that is previously set by the user. For example, the data amount of each of the plurality of pages can be calculated, and the calculated data amount can be compared with the predetermined reference data amount, and pages can be grouped according to a comparison result.

Here, operations 30 and 32 are performed before the printing of the document is required by the user. When the printing of the document is required by the user, operation 34 can be performed.

In operation 34, the group to which the page required to be printed belongs is determined, and data of the page required to be printed according to N set for the determined group is processed. For example, when N is set as 1 for the determined group, the data of the page required to be printed is processed as data that can be commercially printed. However, when N is set as greater than 1 for the determined group, the data of the page required to be printed is processed as data that can be multiple printed.

In the printing method according to the above-described embodiment of the present invention, the plurality of pages can be grouped based on the complexities of contents and forms of each of the plurality of pages. In this case, if the contents and forms of a group are more complicated, N is set smaller for that group.

Hereinafter, the structure and operation of a printing apparatus using the multiple pages per side (Nup) function which performs the printing method according to the embodiment of the present invention illustrated in FIG. 3 will be described with reference to the accompanying drawings.

FIG. 6 is a block diagram of a printing apparatus using the multiple pages per side (Nup) function according to the embodiment of the present invention illustrated in FIG.3. The printing apparatus includes a user interface unit 40, a printer driving unit 42, a multiple page processing portion 44, a commercial page processing portion 46, and a graphics device interface (GDI) 48.

First, the printing apparatus shown in FIG. 6 performs the printing method shown in FIG. 3 as follows.

In order to perform operation 20, the user interface unit 40 receives pages set by a user to be multiple printed out of a plurality of pages. In order to perform operation 22, the printer driving unit 42 determines whether a page required to be printed is a page set to be multiple printed and outputs the result to the multiple page processing portion 44 and the commercial page processing portion 46, respectively. Here, the page required to be printed can be provided from an application program via the GDI 48. As described previously, the GDI 48 converts data of the page required to be printed that is generated in the application program into languages that can be understood by the printer driving unit 42.

In order to perform operation 26, if it is determined by the printer driving unit 42 that the page required to be printed is a page set to be multiple printed, the multiple page processing portion 44 processes the data of the page required to be printed as data that can be multiple printed.

In order to perform operation 24, if it is determined by the printer driving unit 42 that the page required to be printed is not a page set to be multiple printed, the commercial page processing portion 46 processes the data of the page required to be printed as data that can be commercially printed.

Next, how the printing apparatus shown in FIG. 6 performs the printing method shown in FIG. 4 will be described.

In order to perform operations 27 and 28, the printer driving unit 42 calculates the data amount of a page required to be printed, compares the calculated data amount with a predetermined reference data amount, and outputs the result of the comparison to a page processing unit 50. Here, as described previously, the printer driving unit 42 can receive data of the page required to be printed from an application program via the GDI 48, and can input a predetermined reference data amount through the user interface unit 40.

In order to perform operations 24 and 26 shown in FIG. 4, the page processing unit 50 processes the data of the page required to be printed as data that can be multiple printed or data that can be commercially printed, in response to the result of the comparison by the printer driving unit 42. For example, if it is recognized from the result of the comparison that the calculated data amount exceeds the predetermined reference data amount, the commercial page processing portion 46 of the page processing unit 50 regards the page required to be printed as a page including complicated contents and forms, and processes the data of the page required to be printed as data to be commercially printed. However, if it is recognized from the result of the comparison that the calculated data amount does not exceed the reference data amount, the multiple page processing portion 44 of the page processing unit 50 regards the page required to be printed as a page including no complicated contents and forms, and processes the data of the page required to be printed as data that can be multiple printed.

Last, how the printing apparatus shown in FIG. 6 performs the printing method shown in FIG. 5 will be described.

In order to perform operations 30 and 32, the user interface unit 40 recognizes a plurality of pages grouped into at least one group, recognizes the value of N set by the user with respect to each group, and outputs a recognized result to the printer driving unit 42.

In order to perform operation 34, the printer driving unit 42 and the page processing unit 50 are provided. Here, the printer driving unit 42 determines a group to which the page required to be printed belongs and identifies the value of N set for the determined group. To this end, the printer driving unit 42 can input the group to which each page of the document belongs and the value of N set for each group from the user interface unit 40, and can store the group and N previously. As described previously, the printer driving unit 42 can input the page required to be printed from an application program via the GDI 48.

In this case, the page processing unit 50 processes data of the page required to be printed according to the group determined by the printer driving unit 42 and N identified by the printer driving unit 42. To this end, the page processing unit 50 can be implemented with the multiple page processing portion 44 and the commercial page processing portion 46. Here, when N is identified by the printer driving unit 42 as 1, the commercial page processing portion 46 processes the data of the page required to be printed as data to be commercially printed. When N is identified by the printer driving unit 42 as greater than 1, the multiple page processing portion 44 processes the data of the page required to be printed as data that can be multiple printed by the value of N, which is set for the group to which the page required to be printed belongs.

Meanwhile, when the user interface unit 40 shown in FIG. 6 receives a command for performing printing of the document from the user, the printer driving unit 42 can input data of a page provided from the GDI 48.

Each operation of the printing method according to the previously discussed embodiments of the present invention can be performed by a computer program which can be stored on a computer readable recording medium. In this case, the computer program controls the printing apparatus shown in FIG. 6 to perform the printing method according to those previously discussed embodiments of the present invention.

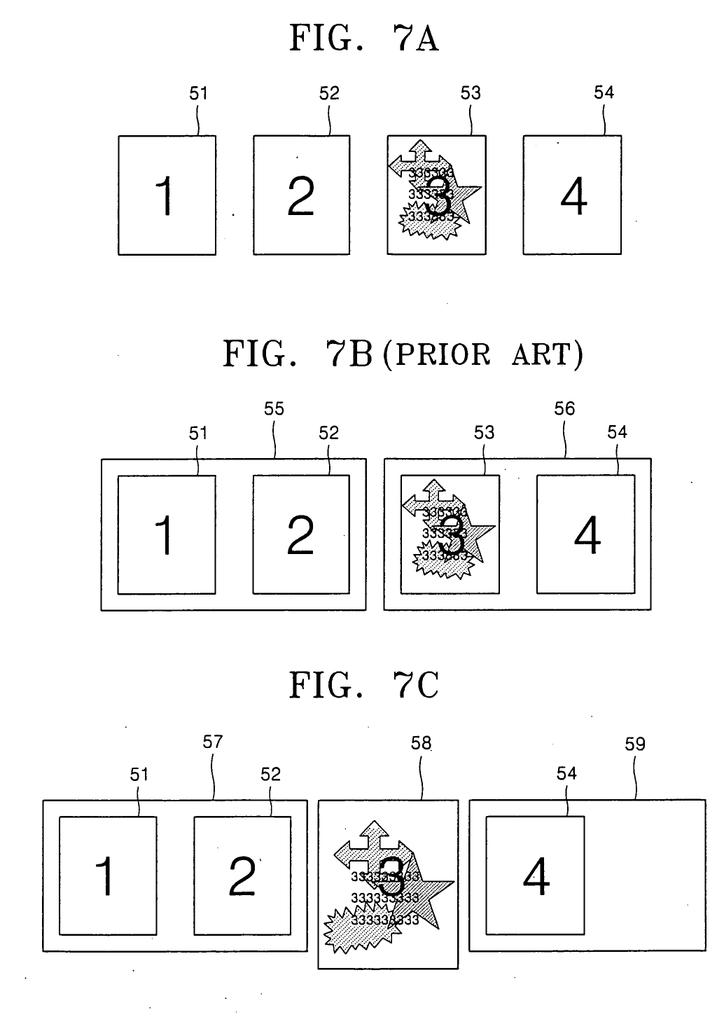

FIGS. 7A through 7C are exemplary drawings illustrating the printing methods according to the embodiments of the present invention illustrated in FIGS. 3 and 4. FIG. 7A illustrates one document including four pages 51, 52, 53, and 54. The first page 51, the second page 52, and the fourth page 54 shown in FIG. 7A include comparatively simple contents and forms, and the third page 53 includes complicated contents and forms.

FIG. 7B illustrates a multiple-printing result of the document shown in FIG. 7A using the conventional printing method. Here, it is assumed that N=2. In other words, the first and second pages 51 and 52 are printed on a first sheet of paper 55, and the third and fourth pages 53 and 54 are printed on a second sheet of paper 56. Thus, as shown in FIG. 7B, the third page 53, which includes complicated contents and forms, is printed on half of the second sheet of paper 56. Thus, the readability of the third page 53 is diminished.

FIG. 7C illustrates a printing result of the document shown in FIG. 7A using the printing method according to the embodiments of the present invention illustrated in FIGS. 3 and 4. Here, it is assumed that N=2 and the first, second, and fourth pages 51, 52, and 54 are pages set to be multiple printed. In this case, the first and second pages 51 and 52 are multiple printed on a first sheet of paper 57, and the third page 53 is commercially printed on a second sheet of paper 58. In other words, since a multiple pages per side (Nup) function is not applied to the third page 53, the third page 53 is printed over the entire second sheet of paper 58. The fourth page 54 is printed in the multiple print style on a third sheet of paper 59. As shown in FIG. 7C, the third page 53, which includes complicated contents and forms, is printed over the entire sheet of paper. Thus, the readability of the third page 53 is increased compared to the conventional method. Here, the multiple pages per side (Nup) function is applied to the fourth page 54, and the fourth page 54 is printed on only half of the third sheet of paper 59. Thus, ink can be saved.

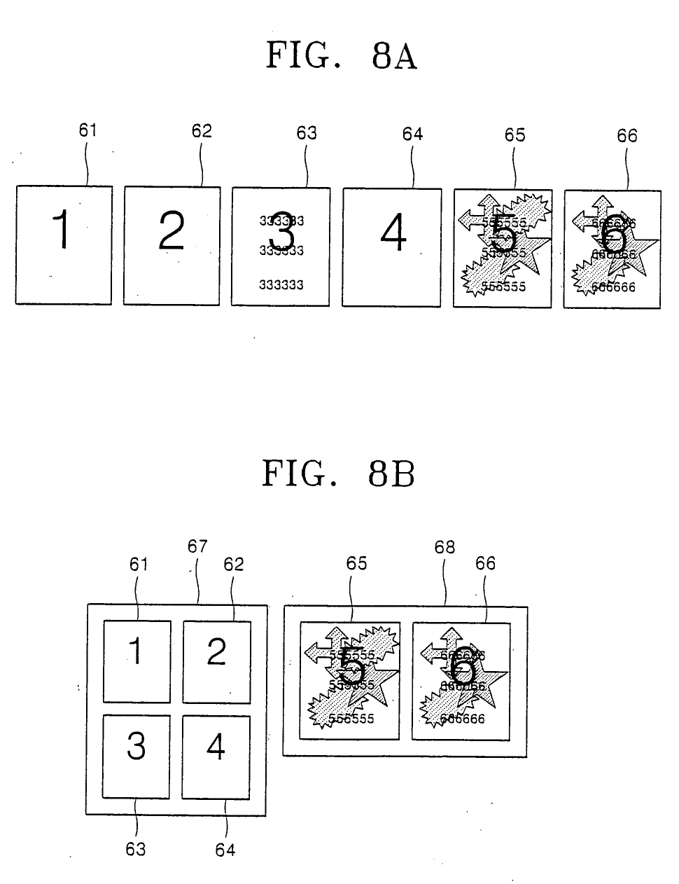

FIGS. 8A and 8B are exemplary drawings illustrating the printing method according to the embodiment of the present invention illustrated in FIG. 5. FIG. 8A illustrates one document including six pages 61, 62, 63, 64, 65, and 66. The first page 61, the second page 62, the third page 63, and the fourth page 64 shown in FIG. 8A include comparatively simple contents and forms, and the fifth page 65 and the sixth page 66 include complicated contents and forms.

FIG. 8B illustrates a multiple-printing result of the document shown in FIG. 8A using the printing method according to the third embodiment of the present invention illustrated in FIG. 5. First, in operation 30, the first through fourth pages 61 through 64 are grouped into a first group, and the fifth and sixth pages 65 and 66 are grouped into a second group. In operation 32, N is set to 4, for example, with respect to the first group, and N is set to 2, for example, with respect to the second group. In operation 34, data of the first, second, third, and fourth pages 61, 62, 63, and 64, which belong to the first group, is processed according to N=4, and data of the fifth and sixth pages 65 and 66, which belong to the second group, are processed according to N=2. In this case, when using the processed result, as shown in FIG. 8B, the first through fourth pages 61 through 64 are printed on a first sheet of paper 67, and the fifth and sixth pages 65 and 66 are printed on a second sheet of paper 68.

Thus, in the printing method according to the third embodiment of the present invention illustrated in FIG. 5, as shown in FIG. 8B, the first through fourth pages 61 through 64, which include comparatively simple contents and forms, are printed on the sheet of paper 67, such that paper and ink can be saved. In addition, the fifth and sixth pages 65 and 66, which include comparatively complicated contents and forms, are printed on the sheet of paper 68, such that the readability of the fifth and sixth pages 65 and 66 is increased compared to a case where four pages are printed on a sheet of paper.

Hereinafter, a printing method using the multiple pages per side (Nup) function by which the number of pages is written on pages to be multiple printed, according to yet another embodiment of the present invention, will be described with reference to the accompanying drawings.

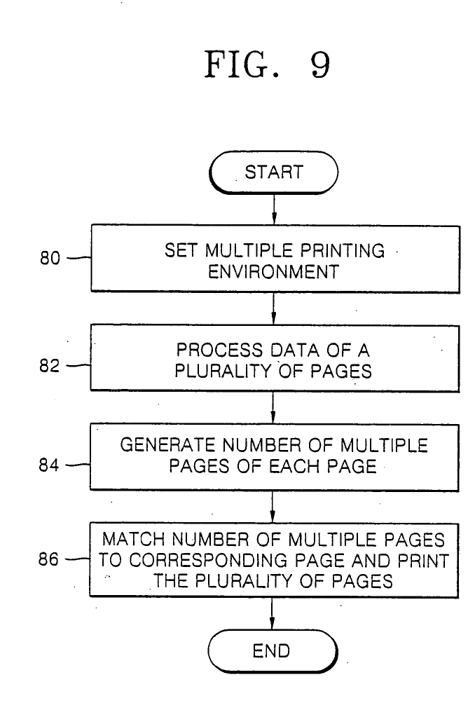

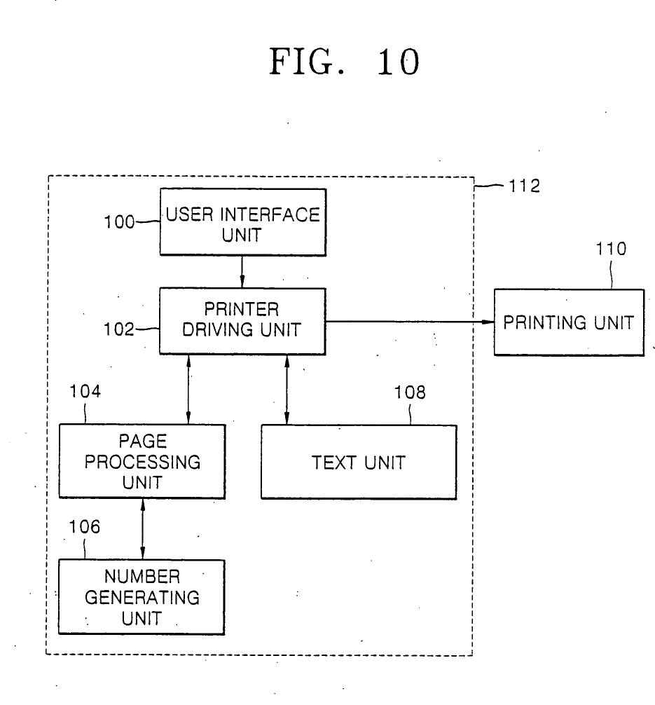

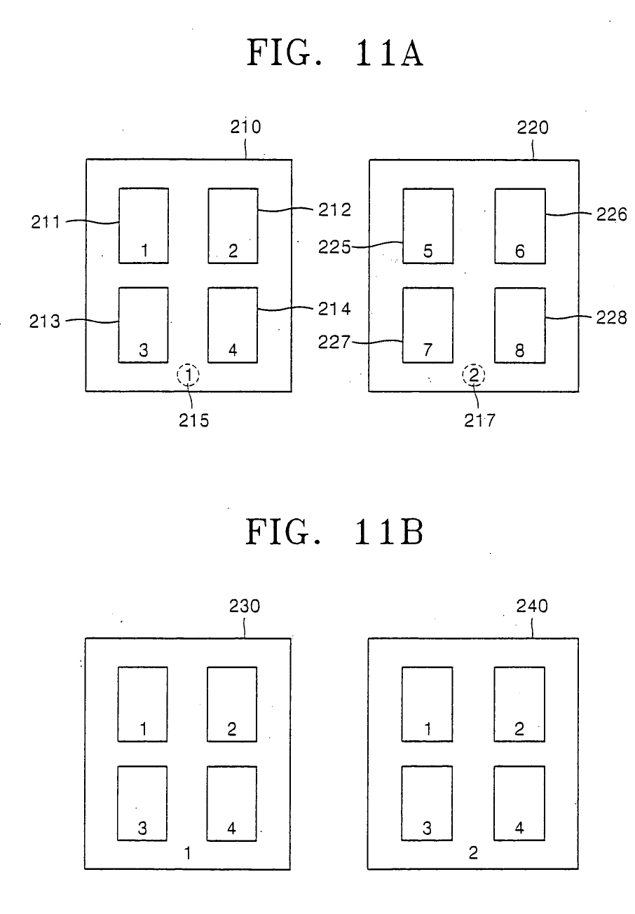

FIG. 9 is a flowchart illustrating the printing method using the multiple pages per side (Nup) function according to this embodiment of the present invention.

In operation 80, a printing environment is set by a user. Here, a graphic user interface (GUI) may be provided so that the user can set the printing environment easily. In this case, the printing environment that can be set by the user is classified into a commercial printing environment and a multiple printing environment. Here, the commercial printing environment includes at least one of various printing options, such as the size and type of paper, a printing range, magnification and reduction ratios, printing pages, and page margins per sheet. In this case, according to this embodiment of the present invention, the multiple printing environment includes at least one of N, a request for multiple printing, printing the number of multiple pages, a layout by which pages are to be multiple printed, printing the number of physical pages, position, font style, size, color, and transparency in which the number of multiple pages is printed. The physical pages are the number of pages of a sheet of paper on which a plurality of pages or a single page is printed.

In operation 82, data of a plurality of pages is processed as data that can be multiple printed according to the set printing environment. For example, if it is determined from an analyzed result of the set printing environment that multiple printing is requested, that is, if it is determined that the user has requested multiple printing, data corresponding to the plurality of pages is reduced and is processed as data that can be multiple printed.

In operation 84, the number of multiple pages of each of the plurality of processed pages is generated. For example, if it is determined from the analyzed result of the printing environment set in operation 80 that printing of a number of multiple pages is requested by the user, the number of multiple pages to be printed together with each page is generated.

In operation 86, the plurality of pages are multiple printed, together with a corresponding page number, according to the multiple printing environment using the processed data with respect to each page and the number of multiple pages generated with respect to each page.

In this case, as described previously, the number of multiple pages generated in operation 84 is directly used in operation 86. However, unlike the previously discussed situation, the number of multiple pages generated in operation 84 may be used in operation 86 after a printer command corresponding to the number of multiple pages generated in operation 84 is converted into a file format. For example, when four pages are expected to be multiple printed on a sheet of paper, in operation 84, multiple page numbers 1, 2, 3, and 4, which are to be printed together with the four pages, are generated, and then a printer command for each of the page numbers 1, 2, 3, and 4 is generated in a file format. In this case, in operation 86, the multiple page numbers having the file format are printed together with the corresponding pages.

Meanwhile, various effects of size, position, and transparency may be given to the multiple page numbers printed in operation 86, or may be varied according to the multiple printing environment set by the user.

Hereinafter, the structure and operation of a printing apparatus using the multiple pages per side (Nup) function which performs printing method according to the embodiment of the present invention illustrated in FIG. 9 will be described with reference to the accompanying drawing.

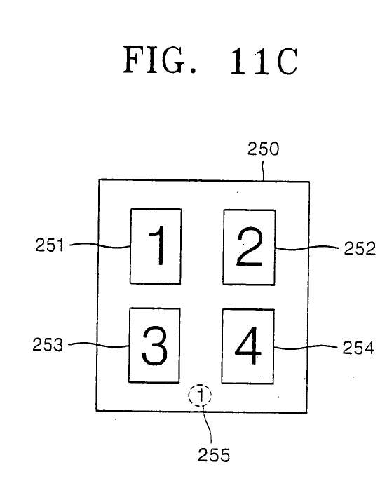

FIG. 10 is a block diagram of the printing apparatus using the multiple pages per side (Nup) function according to this-embodiment of the present invention. The printing apparatus includes a user interface unit 100, a printer driving unit 102, a page processing unit 104, a number generating unit 106, a text unit 108, and a printing unit 110. Here, the user interface unit 100, the printer driving unit 102, the page processing unit 104, the number generating unit 106, and the text unit 108 may be built in a personal computer (PC) 112, and the printing unit 110 may be built in a printer (not shown).

The printing apparatus shown in FIG. 10 performs the printing method illustrated in FIG. 9 as follows.

In order to perform operation 80, the user interface unit 100 receives a printing environment set by a user and outputs the set printing environment to the printer driving unit 102. The user interface unit 100 can provide a graphic user interface (GUI) so that the user can set the printing environment easily.

In order to perform operation 82, the page processing unit 104 processes data of a plurality of pages as data that can be multiple printed according to the set printing environment input from the user interface unit 100 via the printer driving unit 102, and outputs a processed result to the printer driving unit 102. For example, if it is recognized through the printing environment input from the printer driving unit 102 that the user has requested multiple printing, the page processing unit 104 processes the data of the plurality of pages as data that can be multiple printed. For example, the page processing unit 104 reduces the data of the plurality of pages input from the printer driving unit 102 by N, which is the number of pages to be printed on a sheet of paper, and outputs the processed result to the printer driving unit 102 in a layout order set by the user.

In order to perform operation 84, the number generating unit 106 generates the number of multiple pages of each of the plurality of processed pages and outputs the generated number of multiple pages to the printer driving unit 102 via the page processing unit 104. For example, if it is recognized through the printing environment that the user has requested printing of the number of multiple pages, the page processing unit 104 allows the number generating unit 106 to generate the number of multiple pages to be printed together with the plurality of pages. In this case, the number of multiple pages generated by the number generating unit 106 is output to the printer driving unit 102 via the page processing unit 104.

The printer driving unit 102 and the printing unit 110 perform operation 86. In other words, the printer driving unit 102 matches data of the processed page input from the page processing unit 104 to the generated number of multiple pages and outputs a matched result to the printing unit 110 as printing data. In this case, the printing unit 110 matches the plurality of pages to the number of multiple pages and performs multiple printing according to the printing environment, using the printing data input from the printer driving unit 102.

Meanwhile, the printing apparatus shown in FIG. 10, according to this embodiment of the present invention, may further provide the text unit 108 in order to perform operation 84. When the number of multiple pages is input from the number generating unit 106 via the page processing unit 104, the printer driving unit 102 allows the text unit 108 to convert a printer command corresponding to the number of multiple pages into a (printer command) file format. In this case, the printer driving unit 102 matches the processed page data input from the page processing unit 104 to the printer command read from the printer command file input from the text unit 108, and outputs a matched result to the printing unit 110 as printing data.

According to this embodiment of the present invention, after the number of multiple pages is output to the printing unit 110 via the printer driving unit 102, the processed page data may be output to the printing unit 110, and after the the processed page data is output to the printing unit 110 via the printer driving unit 102, the number of multiple pages may be output to the printing unit 110.

Each operation of the printing method according to this embodiment of the present invention can be performed by a computer program which can be stored on computer readable recording media. In this case, the computer program controls the printing apparatus shown in FIG. 10 which performs the printing method according to this embodiment of the present invention. In other words, a function of a portion 112, which can be built in the personal computer (PC), in the printing apparatus shown in FIG. 10, can be implemented with a printer driver of the personal computer (PC).

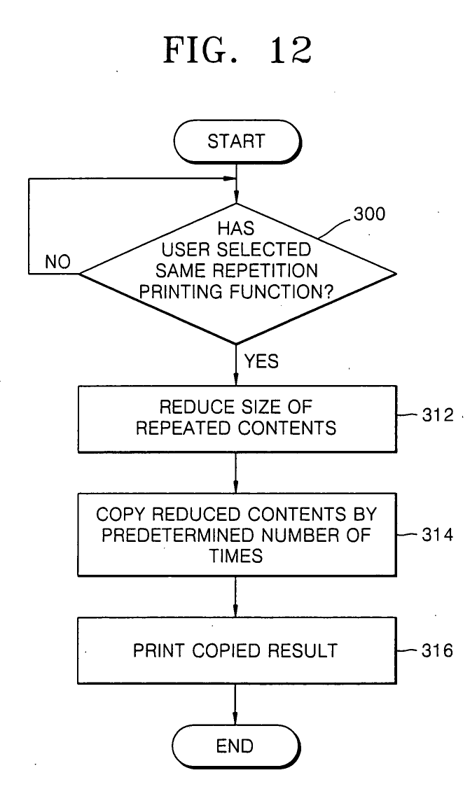

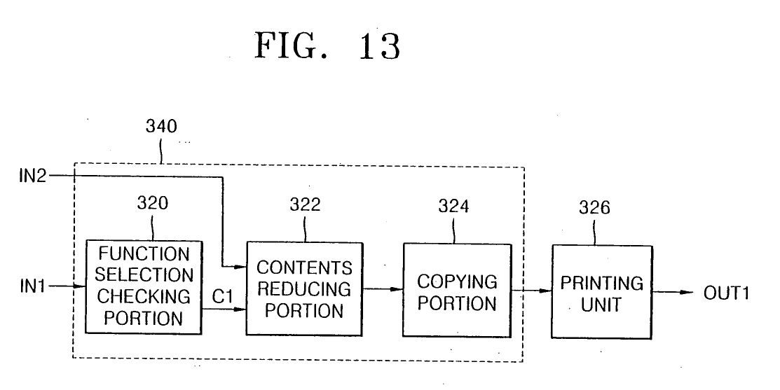

FIGS. 11A through 11C are exemplary drawings for sheets of paper printed by the printing method according to the embodiment of the present invention illustrated in FIG. 9. Referring to FIG. 11A, four pages 211, 212, 213, and 214 are printed on a first sheet of paper, that is, a physical page 210, and four pages 225, 226, 227, and 228 are printed on a second sheet of paper 220 by the printing method according to this embodiment of the present invention. In addition, since each page included in each physical page also includes one of the multiple page numbers 1, 2, 3, 4, 5, 6, 7, or 8, the user can read the multiple page numbers and can see that the document shown in FIG. 11 A is output in a layout order of Left to Right, then Bottom. Further, since the first physical page 210 and the second physical page 220 include unique physical page numbers 215 and 217, respectively, the order of the physical page numbers can be easily determined.

It can be seen that the multiple page numbers 1, 2, 3, 4, 5, 6, 7, and 8 shown in FIG. 11A are consecutively printed even though the physical page numbers are changed.

Referring to FIG. 11B, four pages are printed on each of two physical pages 230 and 240. Multiple page numbers shown in FIG. 11B are not consecutively printed but are initialized by each corresponding physical page, unlike the multiple page numbers shown in FIG. 11A. In other words, whenever the physical pages are changed, the multiple page numbers of each page are newly initialized and printed.

FIG. 11C illustrates pages 251,252, 253, and 254 printed on a physical page 250 having a physical page number ‘1’ (255). In this case, multiple page numbers shown in FIG. 11C are printed faintly, that is, transparently, due to a shadow effect given to the background of each page, unlike the multiple page numbers shown in FIGS. 11A and 11B. In this way, the condition of transparency in which multiple page numbers are printed transparently on each page, can be set by the user in operation 80, as described previously.

Hereinafter, a printing method using the multiple pages per side (Nup) function by which the same contents are repeated, automatically copied, and printed on a sheet of paper by only one user's request, according to yet another embodiment of the present invention will be described with reference to the accompanying drawing.

FIG. 12 is a flowchart illustrating the printing method using the multiple pages per side (Nup) function according to this embodiment of the present invention. The printing method comprises repeatedly copying the same contents on a sheet of paper ( operations 300 through 314) and printing a copied result ( operation 316), if a user has selected a repetition printing function.

In operation 300, it is determined whether the user has selected the repetition printing function of copying and printing identical contents on a sheet of paper N times.

Here, the identical contents, for example, name cards, a few telephone numbers, or simple notices, are made by the user using a general application program. When the user intends to repeatedly print the name cards, telephone numbers, or simple notices on a sheet of paper N times, the user selects the repetition printing function.

If it is determined that the user has selected the repetition printing function, in order to print N of the repeated contents on the sheet of paper, the size of the repeated contents is reduced, in operation 312.

According to this embodiment of the present invention, the ratio of reducing the repeated contents can be determined using a predetermined number of times N, which is the number of times of copying the repeated contents on the sheet of paper, and using a size of the sheet of paper. In this case, the predetermined number of times N may be varied by the user. For example, when the predetermined number of times is 2, in order to print the identical contents twice on the sheet of paper, a size of the contents should be reduced to ½. In other words, when the predetermined number of times N is 2, the reduced ratio is ½.

In operation 314, the reduced contents are copied by the predetermined number of times that can be set or varied by the user.

In operation 316, a copied result is printed on the sheet of paper.

According to this embodiment of the present invention, at least one of operations 310, 312, and 314 can be performed when a printing operation is performed. For example, when operation 316 is performed in a printer (not shown), operations 300 through 314 can be performed by a host (not shown) connected to the printer, for example, by a printer driving unit (not shown) which belongs to a personal computer (PC) (not shown). In other words, operations 310, 312, and 314 can be performed by a computer program of a printer driver.

In the printing method using the multiple pages per side (Nup) function according to this embodiment of the present invention, a printing menu is displayed to the user via a graphic user interface (GUI). When the user presses and selects an icon (not shown) indicating the repetition printing function in the printing menu using a mouse (not shown), the repeated contents are reduced, copied by the predetermined number of times, and provided to a printing engine (not shown) ( operations 300, 312, and 314). In this case, the printing engine prints the repeated contents copied by the predetermined number of times on the sheet of paper (operation 316). In other words, if the user selects the repetition printing function, operations 312, 314, and 316 of reducing the contents and repeatedly printing the reduced contents on the sheet of paper N times are automatically performed.

According to this embodiment of the present invention, the icon indicating the repetition printing function may be included in an N-up printing icon, which is an icon used when printing N pages on the sheet of paper. In other words, the icon indicating the repetition printing function may be at a lower level than the N-up printing icon. That is, if the N-up printing icon is selected, the icon (not shown) indicating the repetition printing function can be automatically displayed.

In this way, in the printing method according to this embodiment of the present invention, the same contents can be repeatedly copied and printed on the sheet of paper using the multiple pages per side (Nup) function.

Hereinafter, the structure and operation of a printing apparatus using the multiple pages per side (Nup) function which performs the printing method according to this embodiment of the present invention will be described with reference to the accompanying drawing.

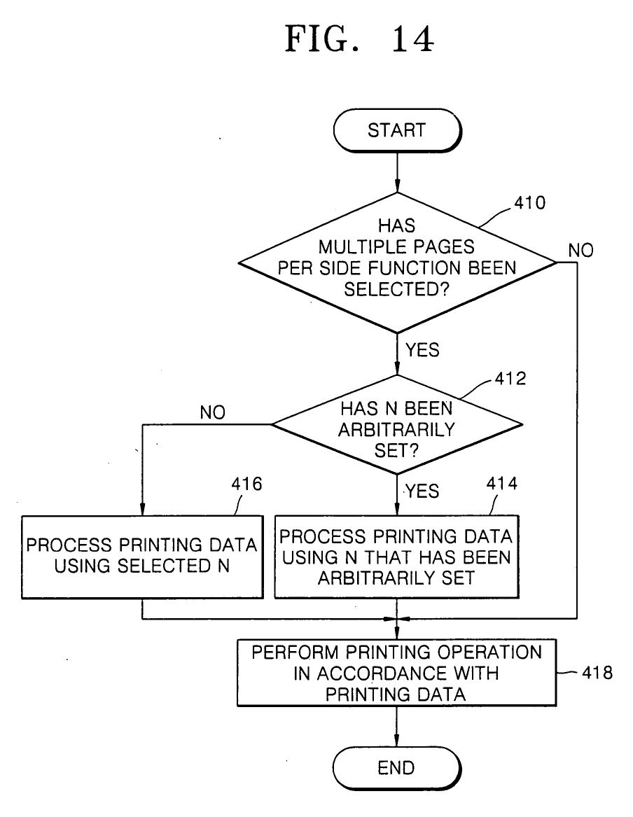

FIG. 13 is a block diagram of the printing apparatus using the multiple pages per side (Nup) function according to the embodiment of the present invention illustrated in FIG. 12. The printing apparatus includes a function selection checking portion 320, a contents reducing portion 322, a copying portion 324, and a printing unit 326.

In order to perform operation 300 shown in FIG. 12, the function selection checking portion 320 checks whether the user has selected the repetition printing function, which repeatedly prints the same contents on a sheet of paper, and outputs a checked result to the contents reducing portion 322 as a first control signal C1. To this end, the function selection checking portion 320 generates a first control signal C1 in response to a function requirement signal that is generated in a key manipulation unit (not shown), manipulated by the user who selects the repetition printing function, which is input through an input terminal IN1.

In order to perform operation 312, the contents reducing portion 322 reduces a size of the repeated contents input through an input terminal IN2, and outputs a reduced result to the copying unit 325 in response to the first control signal C1 input from the function selection checking portion 320. For example, if it is recognized through the first control signal C1 input from the function selection checking portion 320 that the repetition printing function has been selected by the user, the contents reducing portion 322 reduces the size of the contents input through the input terminal IN2. In this case, as described previously, the contents reducing portion 322 can determine the ratio of reducing the contents using a predetermined number of times N, which is a number of times of copying the repeated contents on the sheet of paper, and using the size of the sheet of paper. To this end, the contents reducing portion 322 can store N and the size of the sheet of paper previous to the operation.

In order to perform operation 314, the copying portion 324 copies the reduced contents input from the contents reducing portion 322 by the predetermined number of times and outputs a copied result to the printing unit 326.

In order to perform operation 316, the printing unit 326 prints the copied result input from the copying portion 324 on the sheet of paper and outputs a printed result through an output terminal OUT1.

In this case, at least one of the function selection checking portion 320, the contents reducing portion 322, and the copying portion 324 of the printing apparatus shown in FIG. 13 can be built in a printing driving unit 340 to drive the printing unit 326. Here, the function of the printing driving unit 340 can be performed with a printer driver, for example. Moreover, the printing unit 326 may be included in a printing engine (not shown) of a printer.

Hereinafter, a printing method using the multiple pages per side (Nup) function by which the number of pages to be included in a sheet to be printed and the arrangement of the pages in the sheet can be set by a user, according to yet another embodiment of the present invention, will be described with reference to the accompanying drawings.

FIG. 14 is a flowchart illustrating the printing method using the multiple pages per side (Nup) function according to this embodiment of the present invention. The printing method comprises processing printing data by the value of N (operations 410 through 416) and performing a printing operation (operation 418).

First, in operation 410, it is determined whether a multiple pages per side (Nup) function of printing N pages per sheet has been selected. In this case, the contents of each page can be made by an application program in the personal computer (PC).

If it is determined that the multiple pages per side (Nup) function has been selected, in operation 412, it is determined whether the user has selected N from predetermined values or has set N arbitrarily. In other words, in the conventional method, the user should select N from predetermined values. However, the printing method according to this embodiment of the present invention allows the user to select a value of N that is different from the predetermined values.

If it is determined that the user has set N arbitrarily, in operation 414, printing data corresponding to the contents of a page to be included in the sheet to be printed is processed using the arbitrarily-set N. However, if it is determined that the user has selected N from the predetermined values, printing data is processed using the selected N in operation 416. In other words, considering N, which is arbitrarily set or selected, and the direction of a page to be printed, that is, whether the page is printed in a vertical direction or horizontal direction, the printing data corresponding to the contents of the page to be printed is processed. Here, the printing data may include the arrangement of pages to be printed in a sheet and position information thereon.

According to this embodiment of the present invention, the combination of and arrangement in which N, which has been arbitrarily set by the user or selected from the predetermined values, pages are to be printed on the sheet can be set by the user. In this case, in operation 414 or 416, the printing data is processed according to the desired combination and arrangement.

After operation 414 or 416, or if it is determined that the multiple pages per side (Nup) function has not been selected, in operation 418 the printing operation is performed in accordance with the printing data. For example, after operation 414 or 416, the printing operation is performed in accordance with the processed printing data, that is, the pages are multiple printed. If it is determined that the multiple pages per side (Nup) function has not been selected, the printing operation is performed in accordance with unprocessed printing data, that is, the pages are commercially printed.

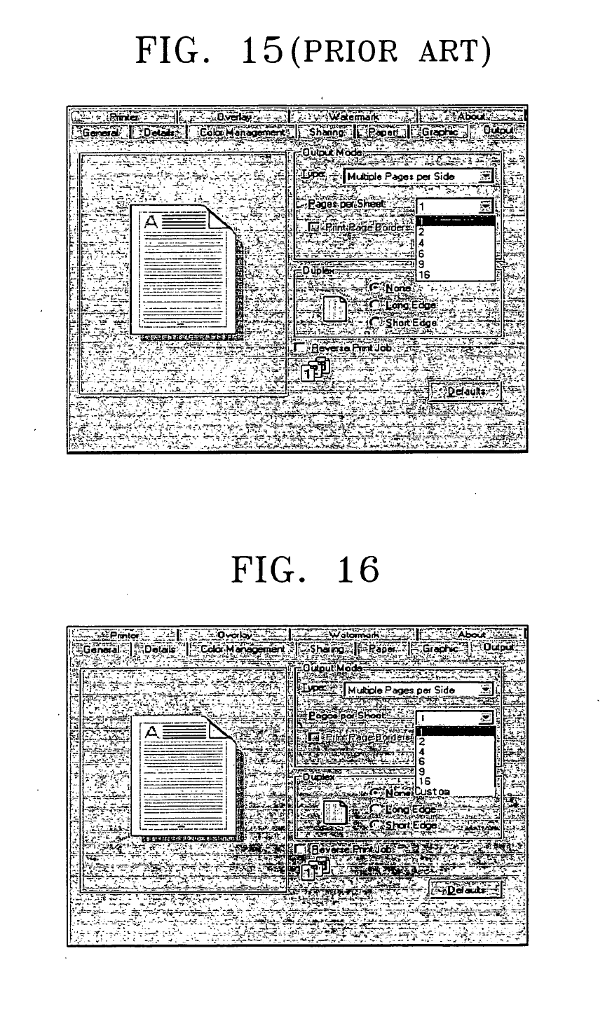

FIG. 15 illustrates an example of a user interface screen provided in a conventional printing method.

FIG. 16 illustrates an example of a user interface screen provided in a printing method using the multiple pages per side (Nup) function according to an embodiment of the present invention.

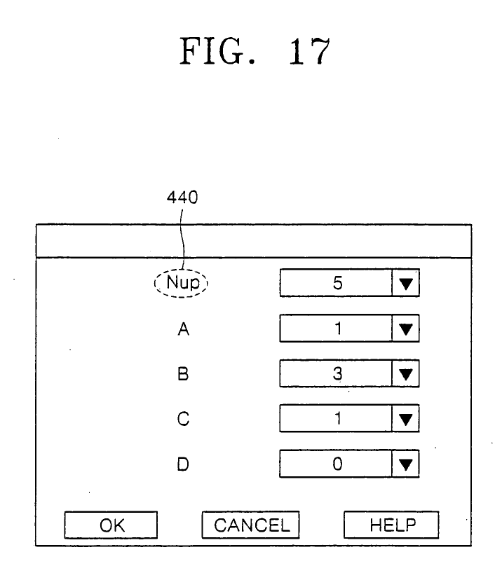

FIG. 17 illustrates an example of a user interface screen displayed when a custom menu of the user interface screen shown in FIG. 16 is selected.

In the conventional printing method, when the user selects the type of printing as multiple pages per side in an output mode of the user interface screen shown in FIG. 15, the user selects pages per sheet, that is, N from predetermined values 1, 2, 4, 6, 9, and 16.

However, in the printing method according to the embodiment of the present invention illustrated in FIG. 14, when the user selects the type of printing as multiple pages per side in the output mode of the user interface screen shown in FIG. 16, a custom menu is provided so that the number of pages to be printed per sheet, that is, N, can be arbitrarily set by the user as a value other than the predetermined values 1, 2, 4, 6, 9, and 16.

In other words, the user who does not intend to select N from the predetermined values, but to set N arbitrarily, clicks a pointing device, such as a mouse, and selects the custom menu. In this case, when the custom menu is selected, the user interface screen shown in FIG. 17 can be displayed. For example, when the user sets N to 5 and divides a sheet to be printed into four regions A, B, C, and D, it is assumed that the user selects the number of pages to be included in the four divided regions A, B, C, and D, respectively, as 1, 3,1, and 0 shown in FIG. 17. In this case, one page is printed in the region A of the sheet, and three pages are printed in the region B of the sheet, and one page is printed in the region C of the sheet, and no page is printed in the region D of the sheet. In other words, by manipulating the user interface screen shown in FIG. 17, the user can set the combination of the pages to be printed per sheet, as well as the arrangement of the pages.

In conclusion, as described previously, the printing method according to the embodiment of the present invention illustrated in FIG. 14 allows the user to set N arbitrarily, and to set the combination of and the arrangement in which N set pages are printed on a sheet. This method is not limited to the case where the sheet is divided into four regions, as shown in FIG. 17. A sheet to be printed can be divided into M (where M is a positive integral number more than 1) regions, according to the desire of the user.

Hereinafter, the structure and operation of a printing apparatus using the multiple pages per side (Nup) function which performs the printing method according to the embodiment of the present invention illustrated in FIG. 14 will be described with reference to the accompanying drawing.

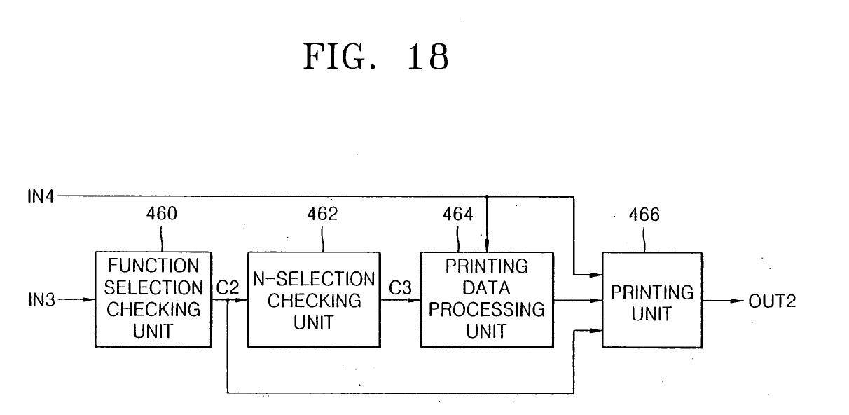

FIG. 18 is a block diagram of the printing apparatus using the multiple pages per side (Nup) function according to this embodiment of the present invention. The printing apparatus includes a function selection checking unit 460, an N-selection checking unit 462, a printing data processing unit 464, and a printing unit 466.

In order to perform operation 410 shown in FIG. 14, the function selection checking unit 460 checks whether the user has selected a multiple pages per side (Nup) function and outputs the result to the N-selection checking unit 462 and the printing unit 466 as a second control signal C2. To this end, the function selection checking unit 460 checks whether an N-up selection signal has been input from a key manipulation unit (not shown), which is manipulated by the user who intends to select the multiple pages per side (Nup) function and generates an N-up selection signal, through an input terminal IN3 and outputs the second control signal C2 in response to a checked result.

In order to perform operation 412, the N-selection checking unit 462 checks whether the user has selected N from predetermined values or has set N arbitrarily in response to the second control signal C2 input from the function selection checking unit 460, and outputs the result to the printing data processing unit 464 as a third control signal C3. In other words, if it is recognized through the second control signal C2 that the user has selected the multiple pages per side (Nup) function, the N-selection checking unit 462 checks whether the user has set N arbitrarily or has selected N from the predetermined values.

In order to perform operations 414 and 416, the printing data processing unit 464 processes printing data corresponding to the contents of a page to be included in a sheet to be printed, using N that is arbitrarily set or selected from the predetermined values, in response to the third control signal C3 input from the N-selection checking unit 462, and outputs a processed result to the printing unit 466. For example, the printing data processing unit 464 inputs the printing data through an input terminal IN4. If it is recognized through the third control signal C3 that the user intends to set N arbitrarily, the printing data processing unit 464 processes the input printing data using the value of N that is arbitrarily set. If it is recognized through the third control signal C3 that the user intends to select N from the predetermined values, the printing data processing unit 464 processes the input printing data using the selected N from the predetermined values. According to this embodiment of the present invention, the printing data processing unit 464 sets the combination of and the arrangement in which N pages that are arbitrarily set or selected from the predetermined values are to be printed on the sheet, and processes the printing data according to the desired result. In other words, as shown in FIG. 17, when the user sets the combination and the arrangement of pages to be printed on the sheet via the user interface screen, the printing data processing unit 464 processes the printing data according to the desired result. Here, the printing data processing unit 464 can input the value of N, which is arbitrarily set or selected from the predetermined values, from an N setting unit (not shown) through the input terminal IN4. Moreover, the N setting unit can be built in the N-selection checking unit 462. In this case, the printing data processing unit 464 inputs N from the N-selection checking unit 462.

In order to perform operation 418, the printing unit 466 performs a printing operation using the printing data, and outputs the result through an output terminal OUT2, in response to the second control signal C2 input from the function selection checking unit 460. For example, if it is recognized through the second control signal C2 that the multiple pages per side (Nup) function has not been selected, the printing unit 466 performs the printing operation using the printing data input through the input terminal IN4. However, if it is recognized through the second control signal C2 that the multiple pages per side (Nup) function has been selected, the printing unit 466 performs the printing operation using the processed printing data input from the printing data processing unit 464.

Meanwhile, the printing method using the multiple pages per side (Nup) function shown in FIG. 14 can be performed by a computer program of a printer driver.

As described above, in the printing method using the multiple pages per side (Nup) function and computer readable recording media storing a computer program according to the embodiments of the present invention illustrated in FIGS. 3 and 4, pages including simple contents and forms are multiple printed such that paper and ink can be saved, and pages including complicated contents and forms are commercially printed such that the readability of the pages is maximized.

In the printing method according to the embodiment of the present invention illustrated in FIG. 5, a group including pages having complicated contents and forms is multiple printed by a small value of N so that the readability of the pages is increased, and a group including pages having simple contents and forms is multiple printed by a large value of N. Therefore, more pages are printed on a sheet of paper so that paper, ink or toner can be saved.

In the printing method according to the embodiment of the present invention illustrated in FIG. 9, since pages output on a sheet of paper have a physical page number and multiple page numbers printed together, the layout of printed multiple pages, that is, the order of pages printed on the single sheet of paper, can be easily seen so that the readability of a document is improved.

In the printing method according to the embodiment of the present invention illustrated in FIG. 12, since an operation of repeatedly copying and printing the same contents on a sheet of paper can be automatically performed by only one user's request, that is, by selecting a repetition printing function, multiple printing of the same contents can be easily performed so that a user does not inconvenience himself and so that the user may easily modify contents copied repeatedly on the sheet of paper.

In the printing method according to the embodiment of the present invention illustrated in FIG. 14, N can be arbitrarily set by the user such that odd number pages as well as even number pages are multiple printed on a sheet of paper. Also, unlike the conventional printing method, where pages are uniformly arranged in a sheet and printed, the combination and arrangement of the pages to be printed on the sheet is set by a user's intention so that the user's convenience of using multiple pages per side (Nup) function is increased.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A printing method using a multiple pages per side (Nup) function, by which a document comprising a plurality of pages is printed using the Nup function of printing multiple pages on a sheet of paper, the method comprising:
setting pages to be multiple printed out of the plurality of pages;
determining whether a page to be printed is one of the pages set to be multiple printed;
processing data of the page to be printed as data to be multiple printed in response to determining that the page to be printed is one of the pages set to be multiple printed;
processing data of the page to be printed as data to be commercially printed in response to determining that the page to be printed is not one of the pages set to be multiple printed; and
printing the plurality of pages according to the processed data.

2. The method of claim 1, wherein the setting pages to be multiple printed out of the plurality of pages comprises setting a page having simple contents and forms to be multiple printed.

3. A printing method using a multiple pages per side (Nup) function, by which a document comprising a plurality of pages is printed using the Nup function of printing multiple pages on a sheet of paper, the method comprising:
calculating a data amount of a page to be printed;
determining whether the calculated data amount exceeds a predetermined reference data amount;
processing data of the page to be printed as data to be multiple printed in response to determining that the calculated data amount does not exceed the predetermined reference data amount;
processing data of the page to be printed as data to be commercially printed, and
printing the plurality of pages according to the processed data.

4. A printing method using a multiple pages per side (Nup) function, by which a document comprising a plurality of pages is printed using the Nup function of printing N pages on a sheet of paper, the method comprising:
grouping the plurality of pages into at least one group;
setting N with respect to each of the at least one group; and
determining which of the at least one group a page to be printed belongs to, and processing data of the page to be printed according to the set N for the determined group.

5. The method of claim 4, wherein the determining which of the at least one group a page to be printed belongs to, and processing data of the page to be printed according to the set N for the determined group comprises:
processing data of the page to be printed as data to be commercially printed in response to the set N for the determined group being 1; and
processing data of the page to be printed as data to be multiple printed in response to the set N for the determined group being greater than 1.

6. The method of claim 4, wherein the plurality of pages are grouped into the at least one group based on complexity of contents and forms of each of the plurality of pages.

7. The method of claim 4, wherein the setting N with respect to each of the at least one group comprises setting N to be inversely proportional to the level of complication of the contents and forms of the corresponding at least one group.

8. A computer readable recording medium storing a computer program to control an apparatus to print a document comprising a plurality of pages using a multiple pages per side (Nup) function of printing multiple pages on a sheet of paper, wherein the computer program controls the apparatus to perform a process comprising:
setting pages to be multiple printed out of the plurality of pages;
determining whether a page to be printed is one of the pages set to be multiple printed;
processing data of the page to be printed as data to be multiple printed in response to determining that the page to be printed is one of the pages set to be multiple printed;
processing data of the page to be printed as data to be commercially printed in response to determining that the page to be printed is not one of the pages set to be multiple printed; and
printing the plurality of pages according to the processed data.

9. A computer readable recording medium storing a computer program to control an apparatus to print a document comprising a plurality of pages using a multiple pages per side (Nup) function of printing N pages on a sheet of paper, wherein the computer program controls the apparatus to perform a process comprising:
grouping the plurality of pages into at least one group;
setting N with respect to each of the at least one group; and
determining which of the at least one group a page to be printed belongs to, and processing data of the page to be printed according to the set N for the determined group.

10. A printing method using a multiple pages per side (Nup) function, by which a document comprising a plurality of pages is printed using the Nup function of printing multiple pages on a sheet of paper, the method comprising:
setting a printing environment;
processing data of the plurality of pages as data to be multiple printed, according to the set printing environment;
generating a number indicating an order of the multiple pages to be printed on the sheet of paper; and
multiple-printing the plurality of pages together with corresponding page numbers according to the printing environment according to the processed data and the generated number of multiple pages.

11. The method of claim 10, wherein the printing environment comprises at least one of a number of pages to be printed on a sheet, a request for multiple printing, printing the generated number of multiple pages, a layout by which pages are to be multiple printed, printing a number of physical pages, position, font style, size, color, and transparency in which the generated number of multiple pages is printed.

12. A computer readable recording medium storing a computer program to control an apparatus to print a document comprising a plurality of pages using a multiple pages per side (Nup) function of printing multiple pages on a sheet of paper, wherein the computer program controls the apparatus to perform a process comprising:
recognizing a set printing environment;
processing data of the plurality of pages as data to be multiple printed, according to the set printing environment;
generating a number indicating an order of the multiple pages to be printed on the sheet of paper; and
instructing a printer to multiple-print the plurality of pages together with corresponding page numbers according to the printing environment according to the processed data and the generated number of multiple pages.

13. A printing method using a multiple pages per side (Nup) function, the method comprising:
determining whether a user has selected a repetition printing function of repeatedly printing identical contents on a sheet of paper;
reducing a size of the identical contents in response to determining the user has selected the repetition printing function;
copying the reduced contents a predetermined number of times; and
printing the copied reduced contents on the sheet of paper.

14. The method of claim 13, wherein a ratio to which the identical contents are reduced is determined using a size of the sheet of paper and the predetermined number of times the reduced contents are copied.

15. The method of claim 13, wherein the predetermined number of times the reduced contents are copied is varied by the user.

16. The method of claim 13, wherein at least one of the determining whether the user has selected the repetition printing function, the reducing the size of the identical contents, and the copying the reduced contents is performed along with a printing operation.

17. A computer readable recording medium storing a computer program to control an apparatus to print a plurality of images on a sheet of paper, wherein the computer program controls the apparatus to perform a process comprising:
determining whether a user has selected a repetition printing function of repeatedly printing identical contents on the sheet of paper;
reducing a size of the identical contents in response to determining the user has selected the repetition printing function; and
copying the reduced contents a predetermined number of times,
wherein the copied reduced contents are printed on the sheet of paper.

18. A printing method using a multiple pages per side (Nup) function, the method comprising:
determining whether a multiple pages per side (Nup) function of printing N, where N is a positive integral number more than 1, pages per sheet has been selected;
determining whether a user has selected N from predetermined values or has set N arbitrarily in response to determining that the multiple pages per side (Nup) function has been selected;
processing printing data corresponding to contents of a page to be included in the sheet using the arbitrarily-set N in response to determining the user has set N arbitrarily;
processing printing data using the selected N in response to determining the user has selected N from the predetermined values; and
performing a printing operation in accordance with the printing data after processing the printing data, or in response to determining the multiple pages per side (Nup) function has not been selected.

19. The method of claim 18, wherein the processing printing data corresponding to contents of a page to be included in the sheet using the arbitrarily-set N in response to determining the user has set N arbitrarily further comprises setting a combination of and an arrangement in which the N pages that have been arbitrarily set by the user are to be printed on the sheet.

20. The method of claim 18, wherein the processing printing data using the selected N in response to determining the user has selected N from the predetermined values further comprises setting a combination of and an arrangement in which the N pages that have been selected by the user from the predetermined values are to be printed on the sheet.

21. A computer readable recording medium storing a computer program to control an apparatus to print a document comprising a plurality of pages using a multiple pages per side (Nup) function of printing multiple pages on a sheet of paper, wherein the computer program controls the apparatus to perform a process comprising:
determining whether the multiple pages per side (Nup) function of printing N, where N is a positive integral number more than 1, pages per sheet has been selected;
determining whether a user has selected N from predetermined values or has set N arbitrarily in response to determining that the multiple pages per side (Nup) function has been selected;
processing printing data corresponding to contents of a page to be included in the sheet using the arbitrarily-set N in response to determining the user has set N arbitrarily;
processing printing data using the selected N in response to determining the user has selected N from the predetermined values; and
instructing a printer to perform a printing operation in accordance with the printing data after processing the printing data, or in response to determining the multiple pages per side (Nup) function has not been selected.

22. A printing method using a multiple pages per side (Nup) function, by which a document comprising a plurality of pages is printed using the Nup function of printing multiple pages on a sheet of paper, the method comprising:
processing data of a page to be printed as data to be multiple printed in response to determining that the page to be printed is set to be multiple printed; and
processing data of the page to be printed as data to be commercially printed in response to determining that the page to be printed is not set to be multiple printed.

23. A printing method using a multiple pages per side (Nup) function, by which a document comprising a plurality of pages is printed using the Nup function of printing multiple pages on a sheet of paper, the method comprising:
processing data of a page to be printed as data to be multiple printed in response to determining that a data amount of the page to be printed does not exceed a predetermined reference amount; and
processing the data of the page to be printed as data to be commercially printed in response to the determined data amount exceeding the predetermined reference amount.

24. A printing method using a multiple pages per side (Nup) function, by which a document comprising a plurality of pages is printed using the Nup function of printing multiple pages on a sheet of paper, the method comprising:
generating a page number for each of the multiple pages printed on the sheet of paper; and
printing the page numbers along with the multiple pages on the sheet of paper.
